(19) United States
(12) Patent Application Publication
(10) Pub. No.: US 2015/0031000 A1
(43) Pub. Date: Jan. 29, 2015

(54) Board game for learning arithmetic

(71) Applicant: G BALASEKARAN, Singapore (SG)

(72) Inventor: G BALASEKARAN, Singapore (SG)

(21) Appl. No.: 14/121,030

(22) Filed: Jul. 21, 2014

(30) Foreign Application Priority Data
Jul. 22, 2013 (SG) 2013055959

(51) Int. Cl. G09B 19/22; G09B 23/02

(52) U.S. Cl. CPC G09B 19/22; G09B 23/02
USPC 434/128; 434/191

(57) ABSTRACT

A board game for a plurality of players to learn arithmetic by playing the game with game pieces representative of the players. Each of the players has a first number of tokens, and the game is played on a game board with a dice rollable to advance the game pieces. The board game comprises a vessel for storing a second number of tokens. The game board comprises a plurality of locations extended around a perimeter of the game board. The plurality of locations is delineated for advancement of the game pieces according to a roll of the dice. Each delineated location indicates an arithmetic function operable by each of player based on their corresponding first number of tokens, when the representing game piece arrives on each delineated location.

### TECHNICAL FIELD

The present invention relates to a board game for players to learn arithmetic.

### BACKGROUND

The use of board games is known in the prior art. There are other board games designed for recreational activities, but there are no board games that offer educational benefits to players, especially young learning children. There some mathematics-related games that educate players on concepts of mathematics, but these games tend to be complicated and not in the form of a board game. It can be appreciated that there exists a need for a board game that allows players to play and learn mathematical concepts, such as arithmetic, at the same time. Moreover, the setting of the board game allows multiple players to play the game together and foster relationships among the players, and such interaction is especially important for young children.

Therefore, an object of the present invention is to provide a board game for a plurality of players to learn arithmetic.

### DISCLOSURE OF THE INVENTION

A first aspect of the present invention provides a board game for a plurality of players to learn arithmetic, the board game comprising: a plurality of game pieces representing the plurality of players, each of the plurality of players having a corresponding first number of tokens; a dice rollable for advancing each of the plurality of game pieces; a vessel for storing a second number of tokens; and a game board. The game board comprises a plurality of locations extending around a perimeter of the game board, the plurality of locations delineated for advancement of each of the plurality of game pieces according to a roll of the dice. Each delineated location indicates an arithmetic function operable by each of the plurality of players based on the corresponding first number of tokens, when the representing game piece arrives on each delineated location.

One advantage of integrating arithmetic functions with a board game is that it allows players, especially young children, to stimulate their brains for development thereof. It also allows players to communicate with one another in order to seek help in solving the arithmetic functions, thereby improving their team spirit and communication skills.

Preferably, the arithmetic function is associated with exchanging of tokens between the corresponding first number of tokens and the second number of tokens stored in the vessel. The arithmetic function may comprise at least one of addition, subtraction, multiplication, and division operations. The different arithmetic operations help the players to practice their arithmetic when calculating their number of tokens. In one embodiment of the present invention, the arithmetic function may be a division operation, such that the first number of tokens is reduced to one.

Preferably, at least one from the plurality of locations of the board game is a bonus location. The board game comprises a plurality of bonus cards, wherein one from the plurality of bonus cards is receivable by one from the plurality of players when the representing one of the plurality of game pieces arrives at the bonus location. Each of the bonus cards represents a bonus function operable by each of the plurality of players based on the corresponding first number of tokens. Similar to the arithmetic function above, the bonus function is associated with exchanging of tokens between the corresponding first number of tokens and the second number of tokens stored in the vessel. The bonus function comprises one of addition and subtraction operations. The advantage of the bonus locations and cards is to provide players with additional opportunities to gain more tokens. However, they may also cause players to lose tokens instead, depending on the bonus card.

The board game preferably has a starting location for the plurality of game pieces at one from the plurality of locations. In determining which player starts the board game, each of the plurality of players may pre-roll the dice first, and the highest result from all of the pre-rolls of the dice will start the board game. This advantageously provides a fair method of determining the starting player. The board game may also provide an ending which occurs when all of the plurality of game pieces has advanced through all of the plurality of locations. Further, the player with the highest number of tokens wins at the ending of the board game.

The tokens preferably comprise either game money or pieces of paper. The game board preferably has at least three edges and each of the plurality of locations is labeled on the game board with a geometrical shape. Preferably, the total number of players is between two to four and there is a set of instructions with the board game for teaching the players how to play the board game.

A second aspect of the present invention provides a method of playing board game for a plurality of players to learn arithmetic. The method comprises the steps of: providing a plurality of game pieces representing the plurality of players; providing a corresponding first number of tokens for each of the plurality of players; providing a counting means for advancing each of the plurality of game pieces; requiring each of the plurality of players to activate the counting means to advance the representing game piece; providing a storage means for storing a second number of tokens; and providing a game board. The game board comprises a plurality of locations extending around a perimeter of the game board, the plurality of locations delineated for advancement of each of the plurality of game pieces according to the counting means. The method further comprises the steps of providing an arithmetic function at each delineated location; and requiring each of the plurality of players to operate the arithmetic function based on the corresponding first number of tokens when the representing game piece arrives on each delineated location.

Preferably, the arithmetic function is associated with exchanging of tokens between the corresponding first number of tokens and the second number of tokens stored in the vessel. The arithmetic function may comprise at least one of addition, subtraction, multiplication, and division operations. The different arithmetic operations help the players to practice their arithmetic when calculating their number of tokens. In one embodiment of the present invention, the arithmetic function may be a division operation, such that the first number of tokens is reduced to one.

Preferably, at least one from the plurality of locations of the board game is a bonus location. The method comprises the steps of providing a plurality of bonus cards, and requiring one from the plurality of players to receive one from plurality of bonus cards when the representing one of the plurality of game pieces arrives at the bonus location. Each of the bonus cards represents a bonus function operable by each of the plurality of players based on the corresponding first number of tokens. Similar to the arithmetic function above, the bonus function is associated with exchanging of tokens between the corresponding first number of tokens and the second number of tokens stored in the storage means. The bonus function comprises one of addition and subtraction operations. The advantage of the bonus locations and cards is to provide players with additional opportunities to gain more tokens. However, they may also cause players to lose tokens instead, depending on the bonus card.

The board game preferably has a starting location for the plurality of game pieces at one from the plurality of locations. In determining which player starts the board game, the method requires each of the plurality of players to activate the counting means before starting the game, and the highest activation of the counting means, or the highest result from all the activations of the counting means, will start the board game. This advantageously provides a fair method of determining the starting player. The method may also provide an ending which occurs when all of the plurality of game pieces has advanced through all of the plurality of locations. Further, the player with the highest number of tokens wins at the ending of the board game.

The game board preferably has at least three edges and each of the plurality of locations is labeled on the game board with a geometrical shape. Preferably, the total number of players is between two to four and there is a set of instructions with the board game for teaching the players how to play the board game.

For a better understanding of the present invention and to show how the same may be performed, a preferred embodiment thereof will now be described, by way of non-limiting example only, with reference to the accompanying drawings.

### BRIEF DESCRIPTION OF THE DRAWINGS

Embodiments of the invention will now be described by reference to the accompanying drawings.

FIG. 1 shows a plan view of a preferred embodiment of the board game.

FIG. 2 shows a magnified view of the set of instructions in the preferred embodiment of FIG. 1.

FIG. 3 shows a perspective view of the vessel for storing tokens in the preferred embodiment of FIG. 1.

In the drawings, like parts are denoted by like numerals.

### DESCRIPTION OF THE PREFERRED EMBODIMENTS

A preferred embodiment of the first aspect of the present invention is described hereafter.

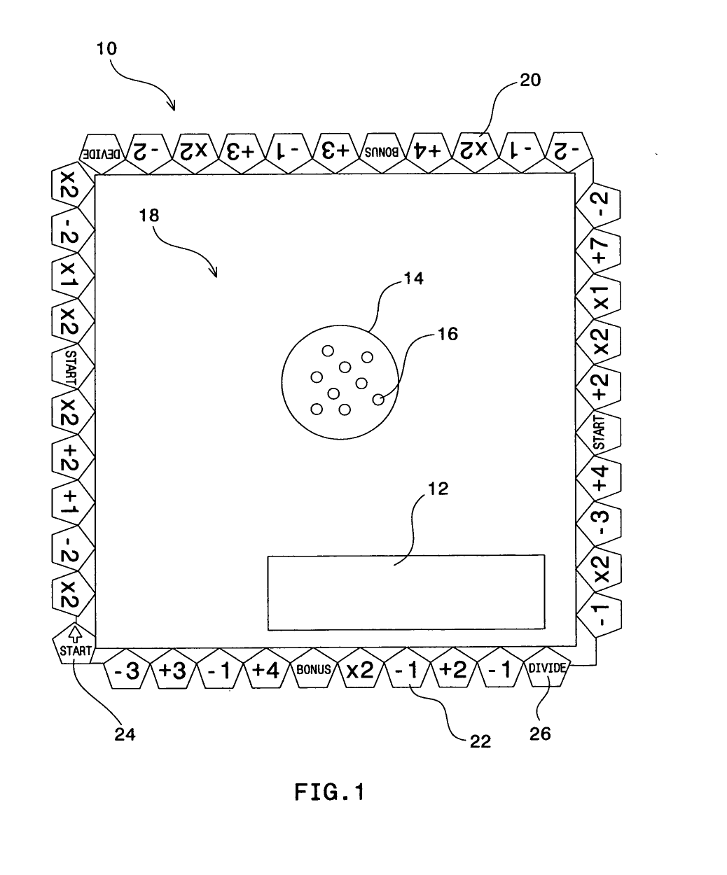

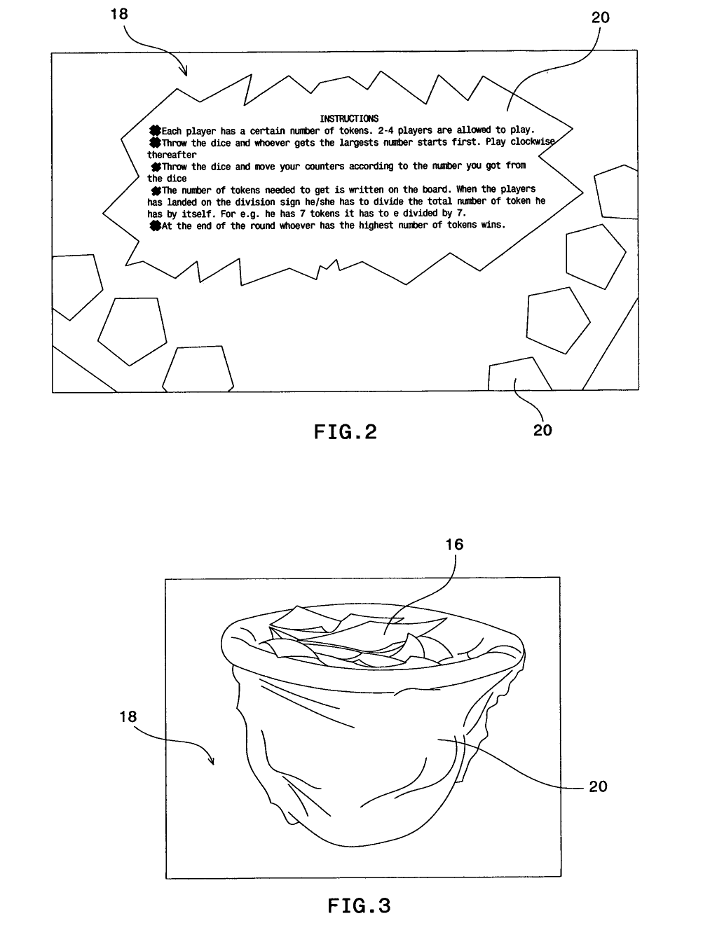

FIG. 1 shows an illustrated board game 10 for a plurality of players (not shown) to play and learn arithmetic over the course of the board game. The number of players may range from two to four inclusive, and the players may be young children who are learning counting, basic arithmetic and mathematics, and the like. To teach and guide the players in playing the board game, the board game 10 may include a set of instructions 12 with it. FIG. 2 shows a magnified view of the set of instructions 12. The board game 10 comprises a plurality of game pieces (not shown) to represent the plurality of players. One game piece represents only one player. Each player has a first number of tokens (not shown) which serves as a form of score counting. These tokens may be, for example, game money or just plain pieces of paper. At the end of the game, the player with the highest number of tokens in possession will be the winner.

There is a dice (not shown) provided with the board game 10 which the players roll in order to advance their respective game pieces. The dice may be a six-faced dice with dots on each face of the dice. The board game 10 further provides a vessel 14, such as a pot or container, for storing a second number of tokens 16. The vessel 14 serves as a token bank wherein players put their tokens into or receive tokens from, depending on the gameplay. FIG. 3 shows a magnified perspective view of the vessel 14 with the second number of tokens 16 stored therein. These tokens may be, for example, game money or just plain pieces of paper.

In order to provide a platform for playing the game, there is a game board 18 whereon the players set their game pieces. The game board 18 may comprise at least three edges, such that the shape may be a triangle or any other polygon. Alternatively, the shape of the game board 18 may be a circle. The game board 18 comprises a plurality of locations 20 extending around a perimeter 22 of the game board 18. Each of the plurality of locations 20 may be labeled on the game board 18 with a geometrical shape, such as a circle, pentagon (as shown in FIG. 1 and FIG. 2), or any other polygon. One from the plurality of locations may be a starting location 24 where the players begin the board game 10 with their game pieces. The plurality of locations 20 is delineated for advancement of each of the plurality of game pieces, according to a roll of the dice. For example, if a player rolls a “4” on the dice; the corresponding game piece moves 4 locations forward. The direction of advancement through the plurality of locations 20 may be clockwise or anti-clockwise. Prior to starting the game, every player may roll the dice once, and the highest result will be the player who starts the game first. The end of the game may occur when all the players have advanced their respective game pieces one complete round through the plurality of locations 20.

Each delineated location 20 indicates an arithmetic function operable by each of the plurality of players when their respective game piece arrives on the delineated location. The arithmetic function is operated based on the corresponding first number of tokens of the player whose game piece has arrived on the delineated location 20. The arithmetic function is associated with exchanging of tokens between the corresponding first number of tokens and the second number of tokens 16 stored in the vessel 14. Depending on the arithmetic function, the player may gain tokens taken from the second number of tokens 16, lose tokens to the second number of tokens 16, or the first number of tokens remains unchanged. Any exchange of tokens between the players and the vessel 14 occurs in full view of all the other players as well, in order to minimize instances of cheating. The arithmetic function may be an addition operation, a subtraction operation, a multiplication operation, a division operation, or any combination thereof. Except for the division operation, all the other operations have a number or an integer associated with it, such as “+1”, “−2”, and “×3”. No number or integer is associated with the division operation—only the division symbol or word having the same meaning is indicated. For example, 26 in FIG. 1 shows one location with a division operation indicated. The division operation causes the first number of tokens to be divided by itself, such that the first number of tokens is reduced to one.

As a form of bonus to the players, the board game 10 provides at least one bonus location from the plurality of locations 20. The bonus location(s) provide(s) some added incentive to help players to gain more tokens. Alternatively or additionally, the bonus location(s) may cause the players to lose tokens instead. The consequence of arriving on a bonus location is dependent on the plurality of bonus cards which come with the board game 10. The plurality of bonus cards may be piled on at least one stack (not shown) adjacent to the vessel 14. One of the bonus cards is receivable by the player whose game piece arrives on the bonus location. Each of the bonus cards represents a bonus function operable by each of the plurality of players when their respective game piece arrives on the bonus location. Similar to the arithmetic function, the bonus function is associated with exchanging of tokens between the corresponding first number of tokens and the second number of tokens 16 stored in the vessel 14. The bonus function may be an addition operation, a subtraction operation, or any combination thereof. For example, a player may encounter a bonus function which represents an addition operation if the player is having a lucky day, and the player may be awarded with 20 new tokens. In another example, if the player is having a bad day, the player may encounter a bonus function which represents a subtraction operation, and may thus lose 10 tokens instead. Therefore, tokens can be added and/or subtracted based on the various operations denoted on the bonus cards.

To add to the environment of gameplay, there may be a theme associated with the board game 10. For example, the vessel 14 may be designed as a pot with a tribal cannibalism concept and the players are seated around the game board 18 with the pot at their centre. This may suggest to the players a theme of a tribal gathering where animals are being cooked inside the pot and at the same time educate the players about prehistoric human times. Besides the tribal theme, other themes and concepts may be applied to the board game 10.

A preferred embodiment of the second aspect of the present invention is described hereafter.

The preferred embodiment is a method of playing the board game 10 in the form of a computer game, software application, and/or mobile app. The board game 10 allows for a plurality of players to play and learn arithmetic over the course of the board game. The number of players may range from two to four inclusive, and the players may be young children who are learning counting, basic arithmetic and mathematics, and the like. To teach and guide the players in playing the board game, the method may provide a set of instructions with the board game. The method comprises providing a plurality of game pieces to represent the plurality of players. The game pieces may be digital avatars representative of the players. One game piece represents only one player. Each player has a first number of tokens which serves as a form of score counting. At the end of the game, the player with the highest number of tokens in possession will be the winner.

There is a counting means provided with the board game which the players activate in order to advance their respective game pieces. The counting means may be a digital six-faced dice with dots on each face of the dice, or any other similar form of counters. The method further provides a storage means, such as a designated location within the game, for storing a second number of tokens. The storage means serves as a token bank wherein players put their tokens into or receive tokens from, depending on the gameplay.

The method provides a platform for playing the game, in the form of a game board whereon the players set their game pieces. The game board may be implemented in the computer game and displayed on a screen for players to view and play the game. The game board may comprise at least three edges, such that the shape may be a triangle or any other polygon. Alternatively, the shape of the game board may be a circle. The game board comprises a plurality of locations extending around a perimeter of the game board. Each of the plurality of locations may be labeled on the game board with a geometrical shape, such as a circle or any polygon. One from the plurality of locations may be a starting location where the players begin the board game with their game pieces. The plurality of locations is delineated for advancement of each of the plurality of game pieces, according to the counting means. For example, if a player activates a result of “4” on the counting means (e.g. a digital dice), the corresponding game piece moves 4 locations forward. The direction of advancement through the plurality of locations may be clockwise or anti-clockwise. Prior to starting the game, every player may activate the counting means once, and the highest activation of the counting means (i.e. the highest result) will be the player who starts the game first. The end of the game may occur when all the players have advanced their respective game pieces one complete round through the plurality of locations.

Each delineated location provides an arithmetic function. The method requires each of the plurality of players to operate the arithmetic function when their respective game piece arrives on the delineated location. The arithmetic function is operated based on the corresponding first number of tokens of the player whose game piece has arrived on the delineated location. The arithmetic function is associated with exchanging of tokens between the corresponding first number of tokens and the second number of tokens stored in the storage means. Depending on the arithmetic function, the player may gain tokens taken from the second number of tokens, lose tokens to the second number of tokens, or the first number of tokens remains unchanged. The arithmetic function may be an addition operation, a subtraction operation, a multiplication operation, a division operation, or any combination thereof. Except for the division operation, all the other operations have a number or an integer associated with it, such as “+1”, “−2”, and “×3”. No number or integer is associated with the division operation—only the division symbol or word having the same meaning is indicated. The division operation causes the first number of tokens to be divided by itself, such that the first number of tokens is reduced to one.

As a form of bonus to the players, the method provides at least one bonus location from the plurality of locations. The bonus location(s) provide(s) some added incentive to help players to gain more tokens. Alternatively or additionally, the bonus location(s) may cause the players to lose tokens instead. The method provides a plurality of bonus cards and the consequence of arriving on a bonus location is dependent on the plurality of bonus cards. The method requires the player whose game piece arrives on the bonus location to receive one of the bonus cards. Each of the bonus cards represents a bonus function operable by each of the plurality of players when their respective game piece arrives on the bonus location. Similar to the arithmetic function, the bonus function is associated with exchanging of tokens between the corresponding first number of tokens and the second number of tokens stored in the storage means. The bonus function may be an addition operation, a subtraction operation, or any combination thereof. For example, a player may encounter a bonus function which represents an addition operation if the player is having a lucky day, and the player may be awarded with 20 new tokens. In another example, if the player is having a bad day, the player may encounter a bonus function which represents a subtraction operation, and may thus lose 10 tokens instead. Therefore, tokens can be added and/or subtracted based on the various operations denoted on the bonus cards.

To add to the environment of gameplay, there may be a theme associated with the board game. For example, the storage may be designed as a pot icon/avatar with a tribal cannibalism concept. Besides the tribal theme, the method may provide for alternate themes and concepts which the players may apply to the board game.

Some examples of playing the board game 10 in accordance with aspects and embodiments of the present invention are described hereinafter.

In a first example of gameplay with four players, each player begins with 50 tokens. Thus, the first number of tokens is 50. Each of the four players takes turns to throw the dice to determine which player will start first. The player whose roll of the dice yields the highest number will start the game first. The gameplay moves in a clockwise direction around the game board 18. The first player throws the dice to begin the game. For example, the player rolls a “3” on the dice and moves 3 steps along the plurality of locations 20.

If the player lands on a location with an addition function, such as “+2”, the player performs the arithmetic function of adding “2” to the number rolled on the dice, i.e. “3”. The result of the arithmetic function, i.e. 2+3=5, will be the number of tokens the player collects from the second number of tokens 16. The player thus gains 5 tokens from this turn.

If the player lands on a location with a subtraction function, such as “−2”, the player performs the arithmetic function of subtracting “2” to the number rolled on the dice, i.e. “3”. The result of the arithmetic function, i.e. 3−2=1, will be the number of tokens the player collects from the second number of tokens 16. The player thus gains 1 token from this turn. If the result of the subtraction function is zero or lower, the player does not collect any token from the second number of tokens 16.

If the player lands on a location with a multiplication function, such as “×2”, the player performs the arithmetic function of multiplying “2” to the number rolled on the dice, i.e. “3”. The result of the arithmetic function, i.e. 2×3=6, will be the number of tokens the player collects from the second number of tokens 16. The player thus gains 6 tokens from this turn.

If the player lands on a location with a division function, the player performs the arithmetic function of dividing the number of tokens held by the player, i.e. the first number of tokens, by itself. As the number is divided by itself, the result will be 1, which will be the number of tokens the player collects from the second number of tokens 16. The player thus gains 1 token from this turn. In other words, the player always only gains 1 token if the player lands on a location with a division function.

If the player lands on a bonus location, the bonus function may require the player to perform an arithmetic function with the number rolled on the dice. Alternatively, the bonus function may allow the player to move a number of steps forward. For example, the bonus function allows the player to move 4 steps forward. This additional move gives the player another opportunity to earn tokens. Whichever location the player lands on, the player will perform the associated arithmetic function using the number of steps allowed by the bonus function in lieu of the roll of the dice.

In a second example of gameplay, the players may perform the arithmetic functions indicated on the plurality of locations 20 directly on their respective first number of tokens, instead of together with the numbers rolled on the dice. If the player lands on the arithmetic function “+2”, the player gains 2 tokens from the second number of tokens 16. If the player lands on the subtraction function “−2”, the player loses 2 tokens to the second number of tokens 16. If the player lands on the multiplication function “×2”, the player doubles his first number of tokens, and collects the corresponding number of tokens from the second number of tokens 16. If the player lands on the division function, the player loses tokens to the second number of tokens 16, until his first number of tokens reduces to 1.

In both examples of gameplay, the players can continue the board game 10 by playing as many rounds as possible around the game board 18, until the second number of tokens 16 stored in the vessel 14 becomes zero. The player with the most number of tokens wins the game. Alternatively, the players may predetermine the number of rounds around the game board 18 to play. Yet alternatively, the players may predetermine a winning number of tokens to obtain, such that the first player to earn that winning number of tokens wins the game.

While various aspects and embodiments have been disclosed herein, the present invention described herein is susceptible to variations, modifications and/or additions other than those specifically described. Other aspects and embodiments will be apparent to those skilled in the art. The various aspects and embodiments disclosed herein are for purposes of illustration and are not intended to be limiting. It is to be understood that the invention includes all such variations, modifications and/or additions which fall within the scope and spirit of the disclosure being indicated by the following claims.

1. A board game for a plurality of players to learn arithmetic, the board game comprising:
a plurality of game pieces representing the plurality of players, each of the plurality of players having a corresponding first number of tokens;
a dice rollable for advancing each of the plurality of game pieces;
a vessel for storing a second number of tokens; and
a game board comprising a plurality of locations extending around a perimeter of the game board, the plurality of locations delineated for advancement of each of the plurality of game pieces according to a roll of the dice,
wherein each delineated location indicates an arithmetic function operable by each of the plurality of players based on the corresponding first number of tokens, when the representing game piece arrives on each delineated location.

2. The board game according to claim 1, wherein the arithmetic function is associated with exchanging of tokens between the corresponding first number of tokens and the second number of tokens stored in the vessel.

3. The board game according to claim 1, wherein the arithmetic function comprises at least one of addition, subtraction, multiplication, and division operations.

4. The board game according to claim 3, wherein the arithmetic function is the division operation, such that the first number of tokens is reduced to one.

5. The board game according to claim 1, wherein at least one from the plurality of locations is a bonus location.

6. The board game according to claim 5, comprising a plurality of bonus cards, wherein one from the plurality of bonus cards is receivable by one from the plurality of players when the representing one of the plurality of game pieces arrives at the bonus location.

7. The board game according to claim 6, wherein each of the bonus cards represents a bonus function operable by each of the plurality of players based on the corresponding first number of tokens.

8. The board game according to claim 7, wherein the bonus function is associated with exchanging of tokens between the corresponding first number of tokens and the second number of tokens stored in the vessel.

9. The board game according to claim 1, wherein an ending of the board game occurs when all of the plurality of game pieces has advanced through all of the plurality of locations.

10. The board game according to claim 9, wherein one from the plurality of players with the highest corresponding first number of tokens wins at the ending of the board game.

11. A method of playing board game for a plurality of players to learn arithmetic, the method comprising the steps of:
providing a plurality of game pieces representing the plurality of players;
providing a corresponding first number of tokens for each of the plurality of players;
providing a counting means for advancing each of the plurality of game pieces;
requiring each of the plurality of players to activate the counting means to advance the representing game piece;
providing a storage means for storing a second number of tokens; and
providing a game board comprising a plurality of locations extending around a perimeter of the game board, the plurality of locations delineated for advancement of each of the plurality of game pieces according to the counting means,
providing an arithmetic function at each delineated location; and
requiring each of the plurality of players to operate the arithmetic function based on the corresponding first number of tokens when the representing game piece arrives on each delineated location.

12. The method according to claim 11, wherein the arithmetic function is associated with exchanging of tokens between the corresponding first number of tokens and the second number of tokens stored in the storage means.

13. The method according to claim 11, wherein the arithmetic function comprises at least one of addition, subtraction, multiplication, and division operations.

14. The method according to claim 13, wherein the arithmetic function is the division operation, such that the first number of tokens is reduced to one.

15. The method according to claim 11, wherein at least one from the plurality of locations is a bonus location.

16. The method according to claim 15, comprising the steps of:
providing a plurality of bonus cards; and
requiring one from the plurality of players to receive one from plurality of bonus cards when the representing one of the plurality of game pieces arrives at the bonus location.

17. The method according to claim 16, wherein each of the bonus cards represents a bonus function operable by each of the plurality of players based on the corresponding first number of tokens.

18. The method according to claim 17, wherein the bonus function is associated with exchanging of tokens between the corresponding first number of tokens and the second number of tokens stored in the storage means.

19. The method according to claim 11, comprising the step of providing an ending of the board game occurs when all of the plurality of game pieces has advanced through all of the plurality of locations.

20. The method according to claim 19, wherein one from the plurality of players with the highest corresponding first number of tokens wins at the ending of the board game.
